(19) United States
(12) Patent Application Publication
(10) Pub. No.: US 2012/0322530 A1
(43) Pub. Date: Dec. 20, 2012

(54) SYSTEM AND METHOD FOR ELECTRONIC BINGO

(76) Inventor: Michael Moore, Hayden, AL (US)

(21) Appl. No.: 13/163,210

(22) Filed: Jun. 17, 2011

(51) Int. Cl. G06F 17/00

(52) U.S. Cl. 463/19

(57) ABSTRACT

A method for facilitating play of a bingo game via one or more play consoles is disclosed including receiving a user indication at a first console that a first user desires to enter a bingo game, receiving a user indication at a second console that a second user desires to enter the bingo game, and only after receiving a user indication at a second console that a second user desires to enter the bingo game, starting the bingo game. A space on a user's card is marked as being designated if and only if the user positively selects the space as designated. Moreover, a player is designated as bingo winner if and only if the player in question has selected a winning pattern of designated spaces and in addition has identified themselves as a bingo winner. The plurality of player consoles may be located in a common area or may be remote from one another. The player consoles may be personal computers, dedicated bingo consoles or other electronic devices.

### TECHNICAL FIELD

This patent disclosure relates generally to electronic gaming and, more particularly to a system and method for providing legal electronic bingo type gaming.

### BACKGROUND

In many states and countries, gambling is prohibited or severely restricted, with respect to so-called games of chance. This disclosure will refer to Alabama law and practice by way of example, but it will be appreciated that numerous other states have created the same or similar environment with respect to the legality of gambling. While the definition of gambling differs somewhat among states, there are certain activities such as bingo that are traditionally used to provide a community service such as fund-raising and are not typically thought of primarily as gambling, but more as games of skill.

Thus, bingo is sometimes excluded from prohibitions against gambling. However, for the unscrupulous, it is possible to execute a bingo game in a way that it provides a gambling experience rather than a skill experience, and thus to effectively circumvent the prohibitions against gambling. This is undesirable from a social standpoint, and thus certain strictures have arisen confining bingo to certain attributes in order to remain a legal game of skill. However, it has traditionally been impossible to implement a legal electronic bingo system, i.e., one that provides the desired socially beneficial aspects of bingo while meeting the strictures imposed by law.

### SUMMARY

In an aspect of the disclosed principles, a method for facilitating play of a bingo game via one or more play consoles is provided. The method comprises receiving a user indication at a first console that a first user desires to enter a bingo game, receiving a user indication at a second console that a second user desires to enter the bingo game, and only after receiving a user indication at a second console that a second user desires to enter the bingo game, starting the bingo game. The game includes generating one or more bingo cards to be displayed to each user on that user's console, each card having a plurality of rows and columns of spaces, each space having a character and designating a plurality of characters and notifying each user regarding each of the plurality of characters in the sequence in which they were designated. A delay may be included between each such notification to allow each user to mark any matching characters on any of their cards.

A space on a user's card is marked as being designated if and only if the user positively selects the space as designated. Moreover, a player is designated as bingo winner if and only if the player in question has recognized a winning pattern of designated spaces and in addition has identified themselves as a bingo winner. The plurality of player consoles may be located in a common area or may be remote from one another. The player consoles may be personal computers, dedicated bingo consoles or other electronic devices, e.g., a cellphone.

In an embodiment, the player consoles have a touch screen for receiving user input during bingo play. The cards and designated numbers are generated at and transmitted from a remote server via a wired and/or wireless network, as are user notifications. Further aspects and features of the disclosed principles will be appreciated from the following detailed description and the accompanying drawings, of which:

### BRIEF DESCRIPTION OF THE DRAWINGS

FIG. 1 is a schematic network diagram showing the structure of a game system in an embodiment of the invention;

FIG. 2 is a schematic network diagram showing the structure of an alternative game system in an embodiment of the invention;

FIG. 3 is a flowchart showing a process of bingo play via a plurality of player consoles and a central server in accordance with the described embodiments;

FIG. 4 is a simulated player console screen shot in accordance with the described embodiments showing a first condition;

FIG. 5 is a simulated player console screen shot in accordance with the described embodiments showing a second condition;

FIG. 6 is a simulated player console screen shot in accordance with the described embodiments showing a third condition;

FIG. 7 is a simulated player console screen shot in accordance with the described embodiments showing a fourth condition;

FIG. 8 is a simulated player console screen shot in accordance with the described embodiments showing a fifth condition; and

FIG. 9 is a s a simulated player console screen shot in accordance with the described embodiments showing a sixth condition.

### DETAILED DESCRIPTION

In overview, this disclosure relates to an electronic system for facilitating an online bingo game wherein geographically dispersed participants or participants in a common area may engage in a game of bingo without involving themselves in certain activities that may destroy the charitable beneficial nature of the game and render it a prohibited gambling experience.

In the past, certain establishments and persons have allowed games of bingo to be played on slot machines. These games typically lasted only several seconds, and were sometimes executed via computer to avoid slot machine restrictions. In these games, the system would visually drop a collection of virtual balls and then the player would strike a key or button, and a comparison was made between the pattern of the balls as dropped and a corresponding pattern on the player's virtual card. A match would yield a win, and a mismatch would yield a loss.

This type of “bingo” game does not have the social component of bingo as traditionally played on paper, nor does it avoid the traps associated with gambling, and which led to the prohibition on gambling as an initial matter. The instant invention in contrast allows an electronic form of bingo without creating a gambling experience and without losing some of the beneficial aspects of traditional paper bingo.

In an embodiment of the invention, the electronic bingo system ensures that each player uses one or more cards with spaces arranged in columns and rows, e.g., 5×5, with an alphanumeric or other regular designation in each space. Corresponding designations are randomly drawn one by one, and each player, in order to win, must pay strict attention to their card(s) and to the designations being drawn, and must physically act to track drawn designations that correspond to spaces on the players card(s). Failure to properly track drawn designations or to realize when a series of drawn designation creates a “bingo” pattern will result in a loss for the player. Perhaps most importantly, the described bingo system provides the social experience of traditional bingo by ensuring that multiple players are engaged in any given game, even if those players are geographically distant from one another.

It will be appreciated that the system described herein also allows a wider group of individuals to play, since it is easier for disabled individuals to play this form of electronic bingo than to play a physical game based on paper cards and physical chips that must be manipulated. Moreover, providing each player with a console in which to play eliminates problems resulting from hearing or other disabilities that individual players may suffer from in traditional bingo where designations are called out from a sometimes fairly distant position. Moreover, this form of electronic bingo eliminates the need to physically distribute cards and other materials, and the associated inefficiencies. For example, in a system requiring physical distribution of cards, those who receive their cards earlier may gain a tactical advantage by studying their cards early.

Moreover, in cases of a tie, there is typically one party that marks and recognizes their bingo pattern first, but it is traditionally difficult to determine which player won first. However, in the electronic bingo system described herein, the actual winner can be identified even if two players “call” bingo with a fraction of a second of one another. Moreover, if a player that asserts that they have a bingo when, in fact, they do not will not be recognized by the server. This avoids the problem that so often arises in paper bingo of having to stop the flow of the game and then restart when it is discovered the player does not have a bingo.

The electronic bingo system described herein is also able to track and render prizes without delay and to maintain a record of player statistics for tournament play. Finally, it will be appreciated that a computer is more capable of generating truly random designations, in contrast to a physical system wherein minute physical differences may make the drawn designation less truly random. This results in a more fair system for the players involved.

While the play of the game requires some form of payment to fulfill its charitable purpose and collect enough to support prizes for the winners, in an embodiment of the invention, the payment is received in the form of a predetermined PIN that links a player to an account from which each entry fee is drawn, and potentially into which winnings may be deposited. However, in alternative embodiments of the invention, other forms of payment may be used. Such other forms include without limitation coins, tokens, cash, and so on.

In addition or alternatively, each player may be associated with one or more machines, with the winner being identified as a machine which is then associated with a player via a PIN or other mechanism or method. During play, designations randomly generated or virtually “drawn” are announced to players via any suitable system, i.e., visual and/or audible screen notifications, human voice announcement, synthesized voice announcement, etc.

While the designations are drawn every 30 seconds in an embodiment of the invention, the time between numbers may be increased or decreased as desired in alternative embodiments. In an embodiment, the designations flash or are highlighted when drawn, but are not deemed to be marked unless the player acts to mark them. The system may detect and prevent “mass” marking, i.e., a player attempting to simply mark all numbers every time by placing their entire hand on the screen, in the case of a touch screen system.

In a further embodiment, a “bingo” notification lights up somewhere on the screen, but the player does not actually win until they note this fact and actually select the highlighted screen item. Other mechanisms may be used to announce, including a verbal announcement of “bingo” or the like. The game progresses until a player wins or a certain number of designations have been called. In an embodiment, the number of designations is 30, but any suitable limit may be used depending upon designer preference.

On each machine, a player may play multiple cards in an embodiment of the invention, however, in a further embodiment the number of cards per machine is limited to four. The number of rows and columns are preferably five each, but other larger or smaller, symmetrical or nonsymmetrical arrangements may be used in alternative embodiments of the invention.

Although the system contemplates electronic generation of “drawn” designations, it will be appreciated that other means may be used instead. Such other means include physical drawing, electronic drawing or combined physical and electronic drawing. Moreover, although this disclosure contemplates a touch screen playing mechanism by way of example, it will be appreciated that other suitable means may be used, e.g., a mouse or stylus driven marking method and so on.

The exact type of electronic system upon which the game is presented to the user is not critical, but it is envisioned that the game may be played on a computer, i.e., a traditional desktop machine, or on a console, which is dedicated to playing the game and which may be visually associated with the game, e.g., via shape, decoration, setting, etc. A server regulates the game to ensure proper operation, to draw designations, and to execute other non-player functions described herein.

In an embodiment, the server operates multiple sets of games, each set having two or more players, regardless of the number of machines being played, and in an further embodiment the server also supports a tournament mode where all players are involved in the same game, i.e., responding to the same designations. As noted above, the players need not be located in the same location, although the system does not preclude all or some players being located in a common location.

As noted above, there is a component of pay for the game, however, the server may support different pay models. For example, a player may have a subscription to play rather than paying for every game, or pay a number of credits to play. Although it is not a primary embodiment, it is also possible to charge fees as a percentage of the game winnings available, i.e., such that higher pot games may cost more to play.

In another embodiment, the game system, e.g., at the server, includes a provision allowing a rights holder, i.e., licensor, to shut down the game if their requirements are not met. In an embodiment, this provision is exercisable by an independent third party, i.e., an arbitration board or other party, based on a showing of violation.

Although the description mentions prizes of money, it will be appreciated that any suitable compensatory medium may be used, i.e., merchandise, points, recognition, donations to charity, and so on. In an embodiment, a game sponsor may provide their branded merchandise or services as compensation to winners.

It will be appreciated that although this description focuses primarily on the virtualization of traditional bingo in a specific manner and mechanism, that other games may be played in the same manner via slight modifications. For example, Keno may be played via the same system or a Keno type game with all of the elements of bingo stated above.

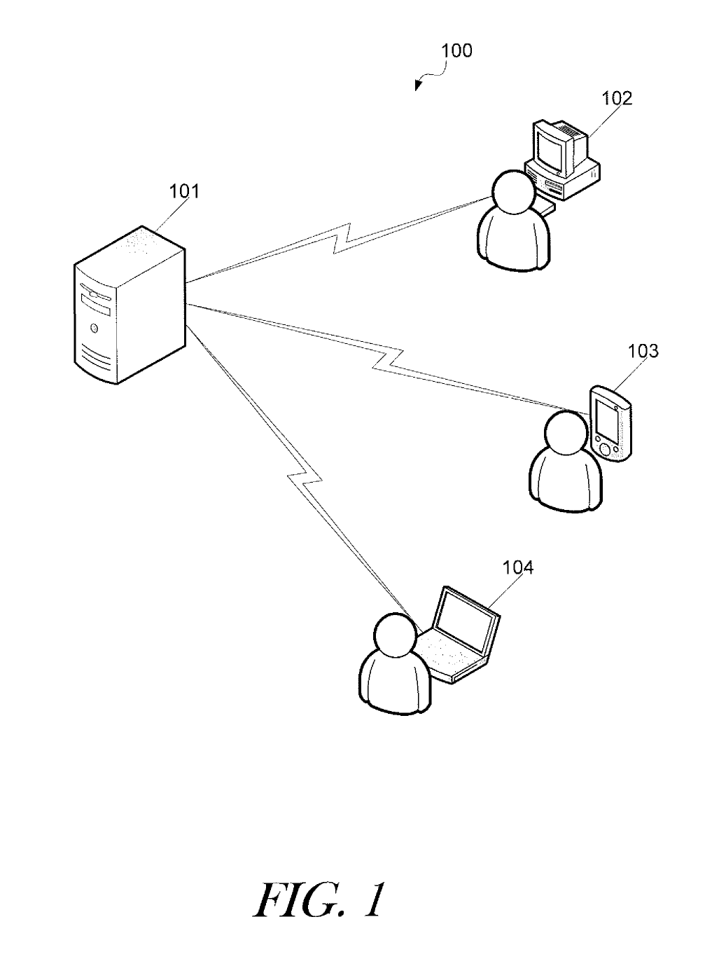

Turning now to the drawings, FIG. 1 is a schematic network diagram showing the structure of a game system in an embodiment of the invention. The system 100 includes a server 101 running software for the regulation and operation of the game, including selecting designations, communicating those designations, receiving user markings of spaces and user claims of winning.

The server 101 is linked via wireless links, wired links, or a combination of the two link types to a plurality of, i.e., two or more, user machines 102-104 for playing the game. As noted above, the user machines may be PCs, consoles, and may also include other device types such as hand-held devices, lap-top devices, built-in computing devices, e.g., in vehicles, and so on. The user machines 102-104 may contain a portion of the operating program in them for playing the game. In other words, although the basic game playing software is all or partially on the server in an embodiment, it is on the user devices in another embodiment.

In an embodiment, it is anticipated that the server 101 will be linked to the plurality of machines 102-104, via the Internet and/or other wide area and potentially international networks. The server 101 comprises or is linked to a memory or database for use in tracking game data, both for individual sets as well as multiple parallel sets or a series of sets, i.e., for tournament play. In an embodiment however, the user machines 102-104 are also used to store some or all game data for one or more machines as a form of redundancy as well as to minimize network latency concerns when appropriate.

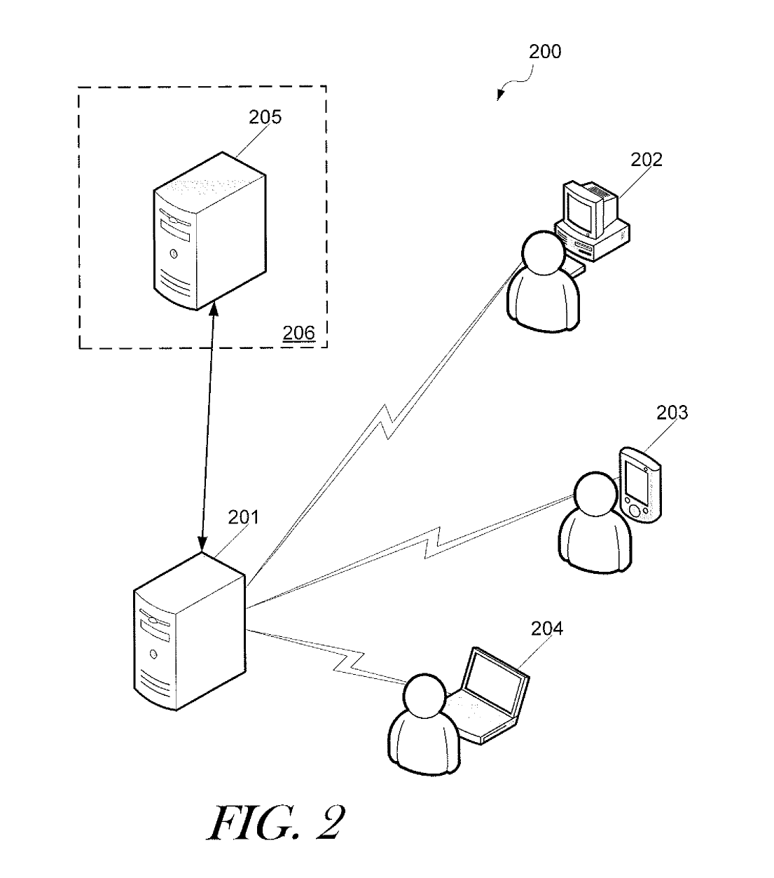

In an alternative embodiment of the invention, the remote server 101 does not generate all game data, e.g., designations, but rather receives this data from another location whereat the data is physically or electronically generated and is then sent to the remote server 101. Such an arrangement is shown in FIG. 2, wherein like numbers reference like elements, e.g., server 101 and 201 correspond to one another, etc.

In this architecture 200, the server 201 is again linked to a series of user machines 202-204 via appropriate wired and/or wireless means. However, an additional remote server 205 is provided at a further remote location 206. In this embodiment, the server 205 acts to interface with physical or computerized game regulation and operation activities at the further remote location 206. For example, the remote location 206 may host a physical designation action, such as a ball drop or otherwise. The results of that activity may then be provided to the server 205, i.e., via data entry or automated means, for transmission to the primary server 201 to be entered into the game.

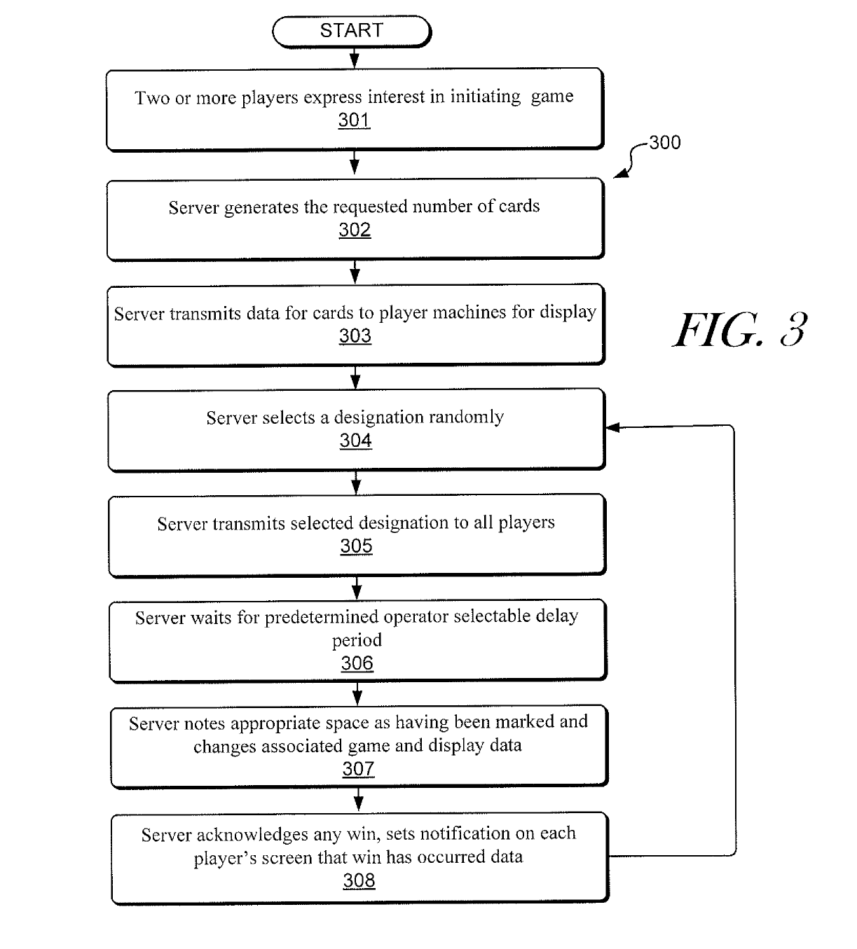

Before looking at specific game screen implementations, a flow chart overview is given of the game play process. Referring now to FIG. 3, the process begins at stage 301 when two or more players have expressed an interest in initiating a game. At this point, the server generates the requested number of cards at stage 302 for each payer and transmits the data for those cards to the individual player machine or machines for display at stage 303. The cards may be randomly generated in real time or may be stored and then retrieved in random order.

The server then selects a designation randomly at stage 304 and transmits the selected designation at stage 305 to all players. Please bear in mind that this example describes a single game set, but that multiple such sets may be coordinated by the server at any given time if needed. At stage 306, the server waits for a predetermined and operator selectable delay period, e.g., 1-30 seconds.

During this time, the server may highlight any spaces to be marked and await user selection, and may also highlight any winning sequences and await user selection. If a marking request is received during this period, the server notes the appropriate space as having been marked and changes the associated game and display data at stage 307 and continues to wait. If a win request is received during this period, the server may acknowledge the win to the winning player and also set a notification on each player's screen that a win has occurred at stage 308. Once any mark is accounted for or if no win or mark occurs during the delay period, the process returns to stage 304 and once again selects a designation randomly.

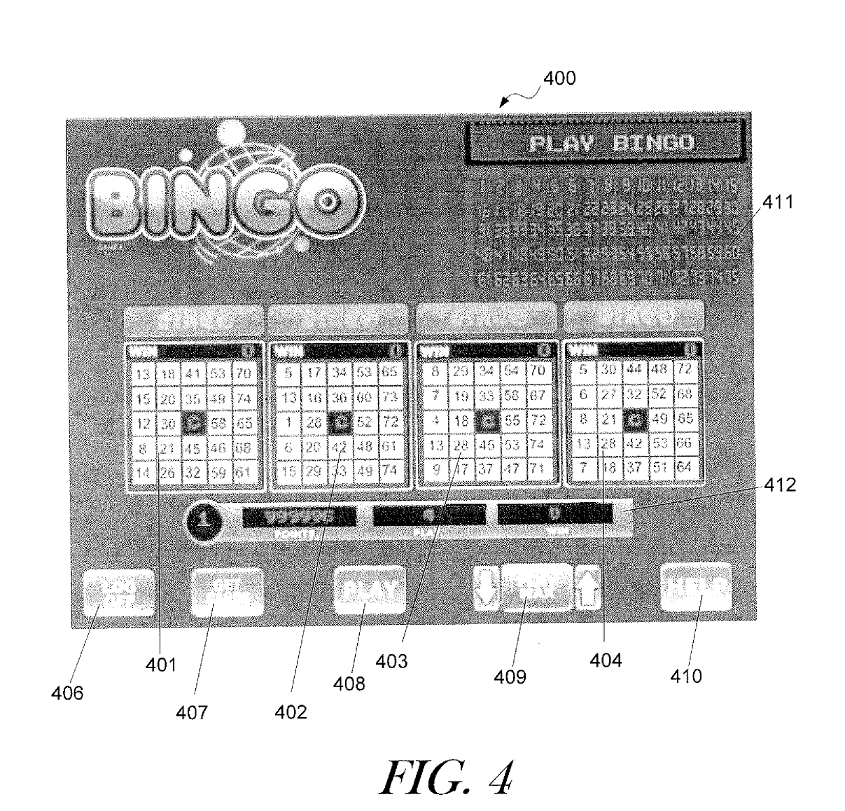

Although the precise visual appearance of the game screen is not critical, an exemplary appearance is shown in FIGS. 4-9 for an embodiment of the invention. These figures, to be discussed below within the context of the user activities and options to establish and engage in play, are simulated screen shots showing a player screen, i.e., on a computer or console screen, at the outset of a game and under various conditions thereafter.

Initially, each person wishing to participate in the bingo game should first visit a cashier window or other purchase location or facility to purchase points. A personal identification number (PIN) will be issued to the player to allow the player to operate the gaming console(s), which as noted may be a simple PC computer with monitor or a dedicated console. In an embodiment, the consoles include a touch screen monitor for play, but other input means are possible as well.

When the players are ready to play, each player enters his or her assigned PIN number and presses a play button. The player will then join a bingo game and participate with one or more other players in the game. As Bingo game numbers, letters, symbols or combinations thereof (generally referred to as bingo “numbers” herein) are randomly designated and announced, all players in a game will receive the same set of random numbers. The player marks, or “daubs,” the numbers on the displayed bingo card using either the mouse or, on a touch screen system, by touching the screen in the appropriate location.

The system then highlights matching numbers on the player's card. This assists handicapped or impaired persons to play the game, although the player must still take action to manually daub the numbers. This process continues until all 30 numbers (or another selected limit) are announced. If at any time a player obtains a “bingo” pattern on one of their cards, they must claim any prize by pressing a bingo button for example. The first player to declare bingo wins the designated price, e.g., double the amount of any winning pattern bingo is declared on. Any manner of betting and prizes may be used without changing the fundamentals of the game.

Sequence players declaring bingo will receive only the regular amount. If a player is not paying attention to the bingo game and fails to daub numbers and/or declare bingo, any potential prize will be lost. As such, player involvement is critical if the player is to take advantage of every opportunity to win. In an embodiment, the system operates over a local area network, with numerous game consoles connected to a central server or servers that manage the game action and databases.

Any one of a number of graphics layouts is usable to effectuate the described principles, but all may use the same functionality and methods to play the game. In a Console model, a player can select different game layouts and graphics as well as denominations to play, ranging from a point having a par value of 0.01 to 0.25 or greater.

An example of a play view is shown in FIG. 4. This figure shows the screen 400 including four playing cards 401-404, as well as various selection and informational fields. The selectable fields include “log off” 406, “get cards” 407, “play” 408, “play max” 409, and “help” 410. The informational fields include the number tracker 411 as well as a status bar 412.

The players may play from 1-10 points on four cards by using the play max buttons for play of 10 points on each card for a total of 40 points or the player may use the arrow keys to select a different play amount per card. Each player uses four cards with spaces arranged in five columns and five rows, with a numeric designation assigned to each space. In the illustrated example, the player enters a bingo game when the player presses play or play max. The bingo console then sends a message over the network to the bingo game server, where the player is entered into the next bingo game. As noted above, the game will not begin until two or more players have entered the particular game.

While the server is waiting for two or more players to enter this bingo game, the console may display a wait message. Additionally or alternatively, the system may display one or more sponsored advertisements, screen shots or pop-ups, and/or may display public service information. After a second player joins, the system will wait for a small while, e.g., 8-10 seconds after the second player enters, before starting, to allow other players to enter this bingo game.

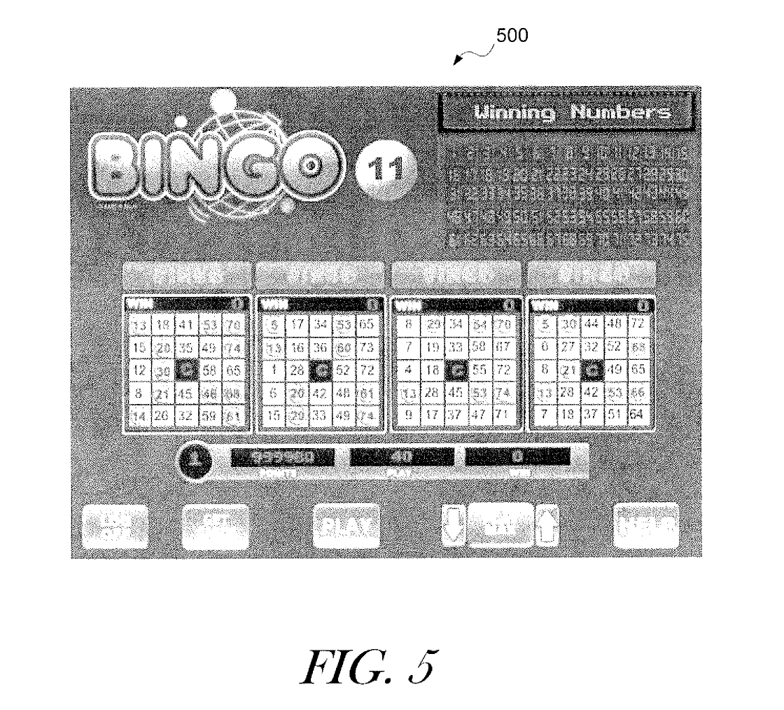

The bingo game starts when the bingo balls start to appear at the game screen. As the bingo balls appear, the corresponding number on the bingo board are highlighted as shown in screen shot 500 of FIG. 5. Balls are announced one at a time and then highlighted on the board. At the same time, the matching ball if any on the cards is highlighted, making it easy for each player to see their hits. This is especially important for players with any impairment or disability. In an alternative embodiment, the highlight feature can be removed or omitted in order to increase the skill level and level of attention needed to successfully play the game. Similarly, reminders that the user has a bingo pattern, discussed elsewhere herein, may be turned off or omitted as well for similar reasons.

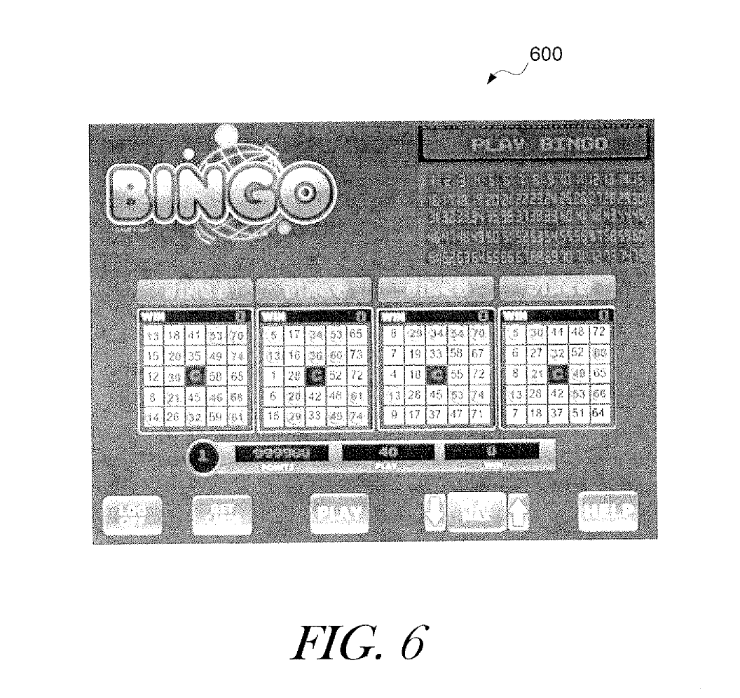

If one of the values matches a value on one or more of the player's cards, the player must physically act by marking his or her card accordingly. Player must daub each number on the cards to mark a winning pattern, and a bingo cannot be declared unless the numbers that represent a winning pattern are daubed. As shown in screen shot 600 of FIG. 6, daubing a number may cause the number on the card to change color or otherwise to show that it has been daubed.

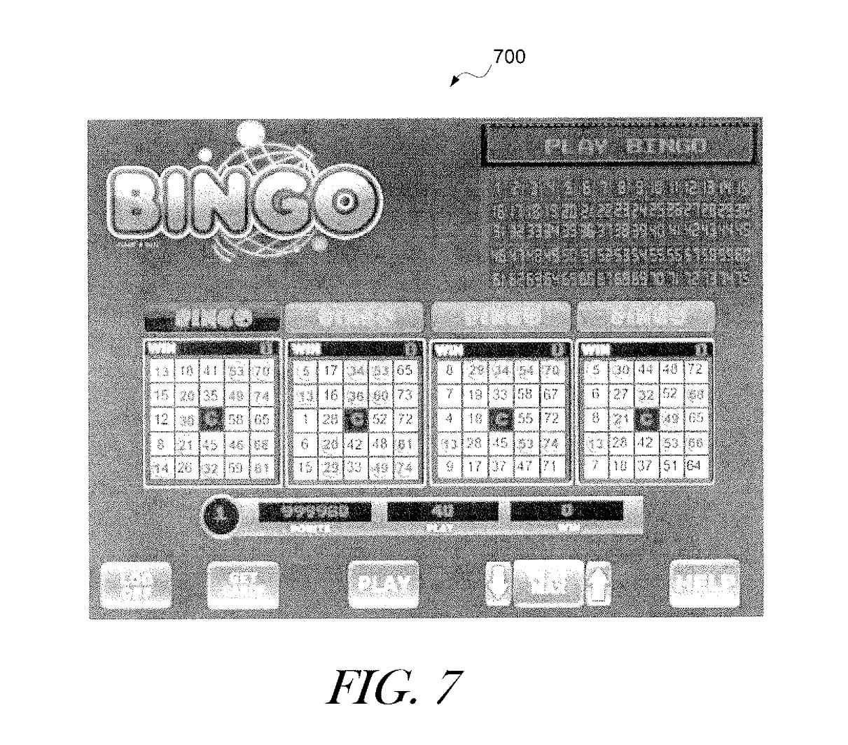

When the player has daubed a set of numbers with designated or “drawn” numbers that form a winning pattern, the bingo button for the associated card is highlighted and is active as shown in screen shot 700 of FIG. 7. The player may then press the bingo button and be the first to declare bingo at this time. In an embodiment, the first player to press bingo will be awarded double prize on the bingo pattern or patterns on which he or she wins bingo. Other players that declare bingo will only be eligible for other prizes and not the bingo prize. This permits an element of strategy for the player to consider. If the player has a single bingo pattern the player may declare bingo at any time or wait for a second pattern. The player may elect to wait for a second pattern and declare bingo on both patterns and increase their winnings. Should another player declare bingo first, the player would not receive the bingo prize.

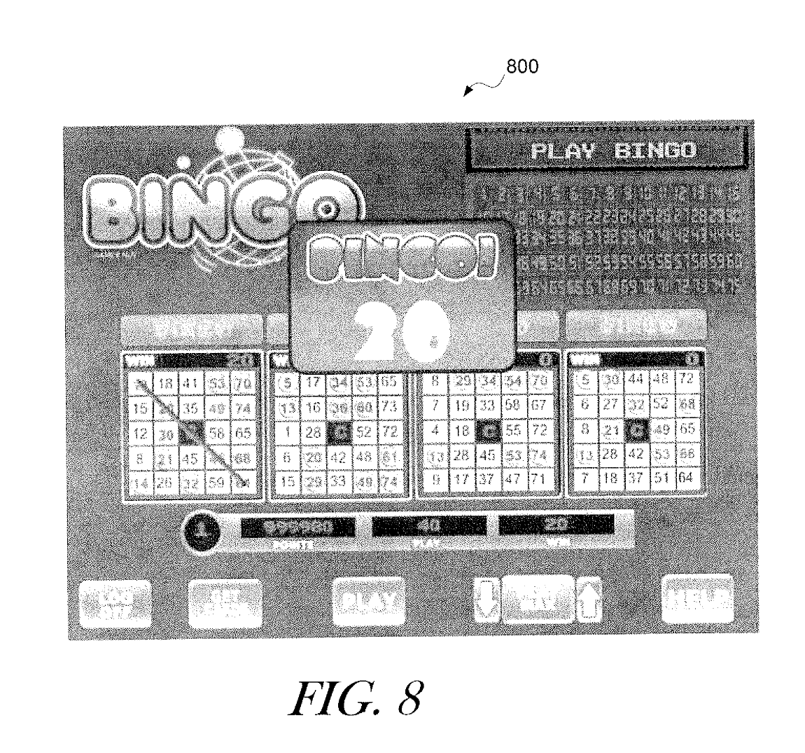

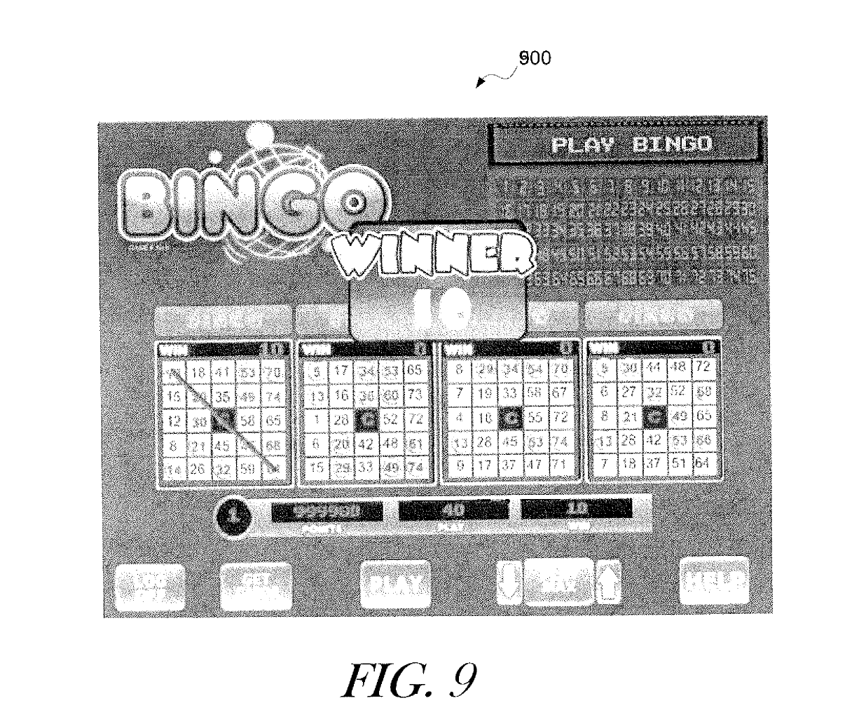

In an embodiment, players that are the first to declare bingo will see an appropriate message on the screen as shown in screen shot 800 of FIG. 8. As noted above, to win the bingo prize a player must recognize that his or her card has a “bingo,” i.e., a predetermined pattern of matching values and declare bingo before any other player does so. Players that daub a winning pattern and press the bingo button after the first player has declared bingo will win the prize for the line as shown in screen shot 900 of FIG. 9. In an embodiment, players can select what type of pattern must be completed to win the game.

In an embodiment, each player will be allowed approximately 2 minutes or other predetermined period after the last balls appears to daub and declare bingo on any winning lines. After the predetermined period has expired, the game will be erased and the player may press play or play max to enter the next bingo game. The next bingo game will not start until two or more players have entered the game, at which time the procedure described above starts over.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method for facilitating play of a bingo game via one or more play consoles, the method comprising:
receiving a user indication at a first console that a first user desires to enter a bingo game;
receiving a user indication at a second console that a second user desires to enter the bingo game;
only after receiving a user indication at a second console that a second user desires to enter the bingo game, starting the bingo game by:
generating one or more bingo cards to be displayed to each user on that user's console, each card having a plurality of rows and columns of spaces, each space having a character;
designating a plurality of characters and notifying each user regarding each of the plurality of characters in the sequence in which they were designated, with a delay between each such notification to allow each user to mark any matching characters on any of their cards;
marking a space on a user's card as being designated if and only if the user positively selects the space as designated; and
designating one of the players as bingo winner if and only if the player in question has recognized a winning pattern of designated spaces and in addition has identified themselves as a bingo winner.

2. The method for facilitating play of a bingo game according to claim 1, wherein the plurality of player consoles are in a common area.

3. The method for facilitating play of a bingo game according to claim 1, wherein the plurality of player consoles are remote from one another.

4. The method for facilitating play of a bingo game according to claim 1, wherein at least one of the plurality of player consoles is a personal computer or other user electronic device.

5. The method for facilitating play of a bingo game according to claim 1, wherein at least one of the plurality of player consoles is a dedicated bingo console.

6. The method for facilitating play of a bingo game according to claim 1, wherein at least one of the plurality of player consoles has a touch screen for receiving user input during bingo play.

7. The method for facilitating play of a bingo game according to claim 1, wherein generating one or more bingo cards to be displayed to each user on that user's console further comprises transmitting the generated cards to the associated consoles via a network from a remote server.

8. The method for facilitating play of a bingo game according to claim 1, wherein notifying each user regarding each of the plurality of characters comprises transmitting the identification of the plurality of characters to the plurality of consoles via a network from a remote server.

9. A system for facilitating play of a bingo game electronically by a plurality of players comprising at least one bingo server and at least two user machines linked to the bingo server, the bingo server being configured to run a bingo game if and only if a user at each of the at least two user machines indicates a desire to play, wherein the running of the bingo game includes randomly selecting space identifiers one-by-one, conveying each selected space identifier to each player via their user machine, designating a bingo card space on a user machine as selected if and only if the respective user has daubed the space, and declaring a player a winner of the bingo game if and only if the player has accurately recognized and declared a winning bingo pattern.
